(19) United States
(12) Patent Application Publication
(10) Pub. No.: US 2026/0147178 A1
(43) Pub. Date: May 28, 2026

(54) LENS MODULE

(71) Applicant: Samsung Electro-Mechanics Co., Ltd., Suwon-si (KR)

(72) Inventors: Min Hyuk IM, Suwon-si (KR); Dong Shin YANG, Suwon-si (KR)

(73) Assignee: Samsung Electro-Mechanics Co., Ltd., Suwon-si (KR)

(21) Appl. No.: 19/343,208

(22) Filed: Sep. 29, 2025

(30) Foreign Application Priority Data
Nov. 27, 2024 (KR) 10-2024-0172695
May 13, 2025 (KR) 10-2025-0062152

(51) Int. Cl. G02B 7/02

(52) U.S. Cl. CPC G02B 7/022; G02B 7/021; G02B 7/028

(57) ABSTRACT

A lens module includes a lens barrel having an internal space; and a first lens and a second lens disposed in the lens barrel along an optical axis direction, wherein each of the first lens and the second lens includes an optical portion exhibiting an optical characteristic, and a support portion extending from the optical portion in an outer diameter direction, the support portion of the first lens includes one of a plurality of grooves and a plurality of protrusions spaced apart from each other in a circumferential direction on a surface facing the second lens, and the support portion of the second lens comprises another one of the plurality of grooves and the plurality of protrusions spaced apart from each other in the circumferential direction on a surface facing the first lens, and the plurality of grooves and the plurality of protrusions contact each other in the circumferential direction.

### CROSS-REFERENCE TO RELATED APPLICATIONS

This application claims the benefit under 35 USC 119(a) of Korean Patent Application Nos. 10-2024-0172695 filed on Nov. 27, 2024, and 10-2025-0062152 filed on May 13, 2025, in the Korean Intellectual Property Office, the entire disclosures of which are incorporated herein by reference for all purposes.

### BACKGROUND

### 1. Field

The present disclosure relates to a lens module.

### 2. Description of Background

Recently, a camera module is being used in a portable electronic device such as a smartphone.

A lens module including a plurality of lenses may be provided in a camera module, and recently, as the number of lenses has been increasing to improve the performance of the camera module, various problems may occur in assembly of the plurality of lenses.

If deformation of the assembly structure between the plurality of lenses occurs due to the occurrence of impacts such as dropping or other impacts and changes in temperature and humidity, optical performance of the lens module may deteriorate.

A lens in which the optical performance degradation does not occur even in the case of such impacts or environmental changes is needed.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens module includes a lens barrel having an internal space; and a first lens and a second lens disposed in the lens barrel along an optical axis direction, wherein each of the first lens and the second lens includes an optical portion exhibiting an optical characteristic, and a support portion extending from the optical portion in an outer diameter direction perpendicular to the optical axis direction, the support portion of the first lens includes one of a plurality of grooves and a plurality of protrusions spaced apart from each other in a circumferential direction perpendicular to the optical axis on a surface of the support portion of the first lens facing the second lens, and the support portion of the second lens includes another one of the plurality of grooves and the plurality of protrusions spaced apart from each other in the circumferential direction on a surface of the support portion of the second lens facing the first lens, and the plurality of grooves and the plurality of protrusions contact each other in the circumferential direction.

The support portion of the first lens and the support portion of the second lens may be spaced apart from each other in the outer diameter direction.

The first lens and the second lens may be made of different materials having different moisture absorption rates, and the plurality of protrusions may be disposed on one of the first lens and the second lens having a higher moisture absorption rate among the first lens and the second lens.

A number of the plurality of grooves may be at least three, and a number of the plurality of protrusions may be at least three.

The number of the plurality of grooves may be greater than the number of the plurality of protrusions.

The plurality of grooves may be disposed at equal intervals in the circumferential direction, and the plurality of protrusions may be disposed at equal intervals in the circumferential direction.

A height of the plurality of grooves in the optical axis direction may be greater than a height of the plurality of protrusions in the optical axis direction.

A distance from a center of the first lens to outer ends of the plurality of grooves or the plurality of protrusions in the outer diameter direction may be smaller than an outer diameter of the first lens, and a distance from a center of the second lens to outer ends of the plurality of grooves or the plurality of protrusions in the outer diameter direction may be smaller than an outer diameter of the second lens.

An angle formed by each surface of each groove of the plurality of grooves contacting a respective protrusion of the plurality of protrusions in the circumferential direction and a bottom surface of the groove perpendicular to the optical axis direction may be an obtuse angle.

The plurality of protrusions and the plurality of grooves may be in line contact or surface contact with each other in the circumferential direction.

A line or a surface on which the plurality of protrusions and the plurality of grooves contact each other in the circumferential direction may extend in the outer diameter direction.

In another general aspect, a lens module includes a lens barrel having an internal space; and a first lens and a second lens disposed in the lens barrel along an optical axis direction, wherein the first lens and the second lens contact each other in a circumferential direction perpendicular to the optical axis direction, the first lens includes one of a plurality of grooves and a plurality of protrusions spaced apart from each other in the circumferential direction on a surface of the first lens facing the second lens, and the second lens includes another one of the plurality of grooves and the plurality of protrusions spaced apart from each other in the circumferential direction on a surface of the second lens facing the first lens, and the plurality of grooves and the plurality of protrusions contact each other on contact surfaces or contact lines extending in an outer diameter direction perpendicular to the optical axis direction and the circumferential direction, and are pressed together in the circumferential direction by a force acting in the circumferential direction.

A number of the plurality of grooves may be at least three, and a number of the plurality of protrusions may be at least three.

The number of the plurality of grooves may be equal to or greater than the number of the plurality of protrusions.

A distance from a center of the first lens to outer ends of the plurality of grooves or the plurality of protrusions in the outer diameter direction may be smaller than an outer diameter of the first lens, and a distance from a center of the second lens to outer ends of the plurality of grooves or the plurality of protrusions in the outer diameter direction may be smaller than an outer diameter of the second lens.

An angle formed by each surface of each groove of the plurality of grooves contacted by a respective protrusion of the plurality of protrusions on a respective contact surface or a respective contact line of the contact surfaces or the contact lines and a bottom surface of the groove perpendicular to the optical axis direction may be an obtuse angle.

The plurality of grooves may be disposed at equal intervals in the circumferential direction, and the plurality of protrusions may be disposed at equal intervals in the circumferential direction.

The first lens and the second lens may be spaced apart from each other in the outer diameter direction.

The first lens and the second lens may be made of different materials having different moisture absorption rates, and the plurality of protrusions may be disposed on one of the first lens and the second lens having a higher moisture absorption rate among the first lens and the second lens.

A height of the plurality of grooves in the optical axis direction may be greater than a height of the plurality of protrusions in the optical axis direction.

Other features and aspects will be apparent from the following detailed description, the drawings, and the claims.

### BRIEF DESCRIPTION OF DRAWINGS

FIG. 1 is a cross-sectional view of a lens module according to an embodiment of the present disclosure.

FIG. 2 is an enlarged view of a portion of the lens module of FIG. 1 illustrating a first lens and a second lens.

FIGS. 3A and 3B are perspective views of the first lens and the second lens of the lens module of FIG. 1.

FIGS. 4A and 4B are a rear view of the first lens and a front view of the second lens of the lens module of FIG. 1.

FIGS. 5A and 5B are enlarged views of a portion of the first lens of FIG. 3A and a portion of the second lens of FIG. 3B.

FIG. 6 is a side view of a first lens and a second lens according to an embodiment of the present disclosure.

FIG. 7 is a side view of a first lens and a second lens according to another embodiment of the present disclosure.

FIG. 8 is a side view of a first lens and a second according to another embodiment of the present disclosure.

FIGS. 9A and 9B are a rear view of a first lens and a front view of a second lens according to another embodiment of the present disclosure.

FIGS. 10A and 10B are a rear view of a first lens and a front view of a second lens according to another embodiment of the present disclosure.

FIGS. 11A and 11B are a rear view of a first lens and a front view of a second lens according to another embodiment of the present disclosure.

FIGS. 12A and 12B are perspective views of an object-side surface and an image-side surface of a first lens according to another embodiment of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

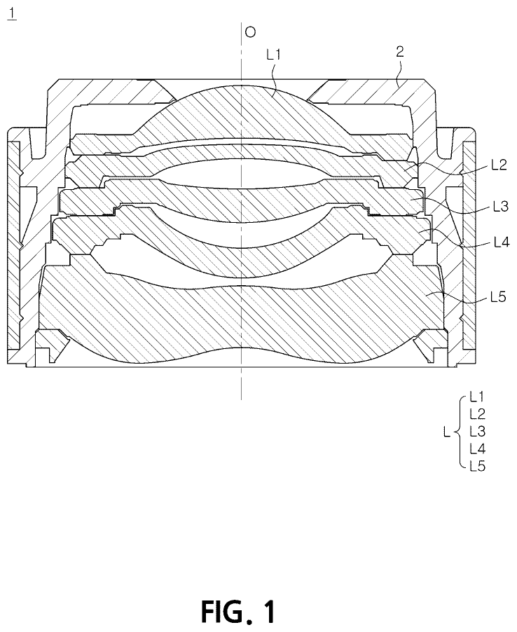

FIG. 1 is a cross-sectional view of a lens module according to an embodiment of the present disclosure.

Referring to FIG. 1, a lens module 1 according to an embodiment of the present disclosure includes a lens barrel 2 and a plurality of lenses L disposed inside the lens barrel 2.

The plurality of lenses L may be sequentially stacked in the lens barrel 2 to assemble the lens module 1.

The lens barrel 2 includes a hollow portion formed therein, and the hollow portion formed therein may be stepped so that an inner diameter thereof increases from an object (subject) side of the lens barrel 2 to an image side of the lens barrel 2.

In another embodiment, the hollow portion formed in the lens barrel 2 may be stepped so that the inner diameter thereof decreases from the object side of the lens barrel 2 to the image side of the lens barrel 2.

The plurality of lenses L are inserted into the stepped inner diameter of the lens barrel 2. Accordingly, the stepped inner diameter of the lens barrel 2 may have inner diameters corresponding to outer diameters of the plurality of lenses L.

The lens module 1 may include at least two lenses, i.e., a plurality of lenses L, disposed inside the lens barrel 2 along an optical axis O. The lens module 1 of the present embodiment may be used in both a wide-angle lens module and a telephoto lens module.

In an embodiment, the lens module 1 includes a first lens L1, a second lens L2, a third lens L3, a fourth lens L4, and a fifth lens L5.

In an embodiment, a structure including five lenses L1 to L5 is disclosed as an example, but this is only an example, and a lens module 1 including at least two lenses is included in all embodiments of the present disclosure.

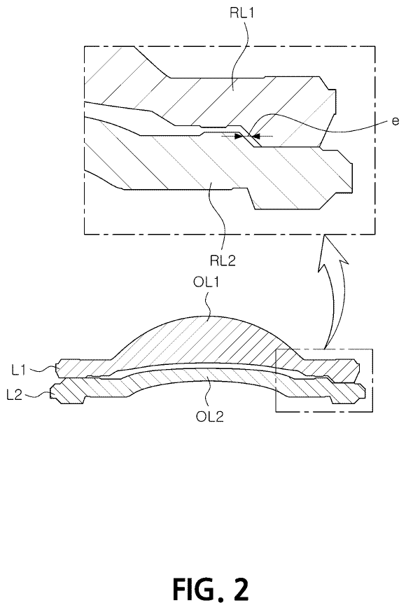

FIG. 2 is an enlarged view of a portion of the lens module of FIG. 1 illustrating a first lens and a second lens.

Referring to FIG. 2, the lenses may include an optical portion exhibiting an optical characteristic, and a support portion including a rib surrounding an edge of the optical portion. The optical portion may exhibit the optical characteristic by itself or in combination with other lenses of the plurality of lenses L. The support portion is not intended to exhibit an optical characteristic, and may be used to support or align the lens with other lenses.

Here, when outer diameters of lenses are referred to without qualification, it should be understood that the entire structure including both the optical portion and the support portion are being referred to.

The optical portion and the rib may be provided in a disc shape, and accordingly, the optical portion may have a circle shape having a predetermined radius centered on an optical axis, and the support portion may be provided in a ring shape on the outside of the optical portion.

Accordingly, the lens barrel 2 having the lens accommodated therein may also have a roughly cylindrical shape.

However, at least one lens may have a D-cut portion in which a portion of the rib is cut off, and the D-cut portion may have a straight shape.

For convenience of explanation, a direction of the edge of the circle having the predetermined radius centered on the optical axis is defined as a circumferential direction.

A direction from the optical axis toward the edge of the circle having the predetermined radius centered on the optical axis is defined as an outer diameter direction.

The optical portion of the first lens L1 is defined as a first optical portion OL1, and the optical portion of the second lens L2 is defined as a second optical portion OL2.

The support portion of the first lens L1 is defined as a first support portion RL1, and the support portion of the second lens L2 is defined as a second support portion RL2.

The first support portion RL1 and the second support portion RL2 may be spaced apart from each other by a distance (e) in an outer diameter direction of the first lens L1 and the second lens L2. For example, in a state in which the first lens L1 and the second lens L2 are assembled, one surface of the first support portion RL1 and one surface of the second support portion RL2 facing each other in the outer diameter direction of the lens may be spaced apart from each other by the distance (e). The distance (e) between the first support portion RL1 and the second support portion RL2 in the outer diameter direction may be constant in the circumferential direction.

That is, the first lens L1 and the second lens L2 may not have portions thereof contacting each other in the outer diameter direction.

When the first support portion RL1 and the second support portion RL2 do not contact each other in the outer diameter direction, an external assembly force (F) between the first lens L1 and the second lens L2 may not be applied in the outer diameter direction.

When an external assembly force (F) between the first lens L1 and the second lens L2 is not applied in the outer diameter direction, a moment toward a center of the lens may be reduced.

When no moment occurs toward the center of the lens, bending of the lens toward the center of the lens may be prevented.

If the bending of the lens toward the center of the lens is prevented, the optical performance of the lens can be prevented from deteriorating.

That is, it is possible to prevent the optical performance of the lens from deteriorating, thereby preventing the overall performance of the lens from deteriorating.

The first support portion RL1 and the second support portion RL2 may be spaced apart from each other by a distance (e) in the outer diameter direction of the first lens L1 and the second lens L2 as shown in FIG. 2. There may be changes in the outer diameter and the inner diameter of the first lens L1 and the second lens L2 due to temperature changes or other environmental influences. Accordingly, the distance (e) may be set to at least a minimum distance that ensures the first support portion RL1 and the second support portion RL2 will not contact each other in the outer diameter direction due to changes in the outer diameter and the inner diameter of the first lens L1 and the second lens L2.

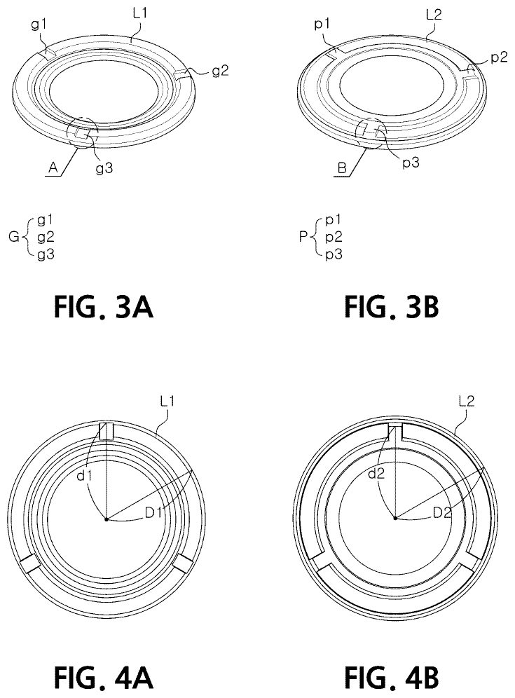

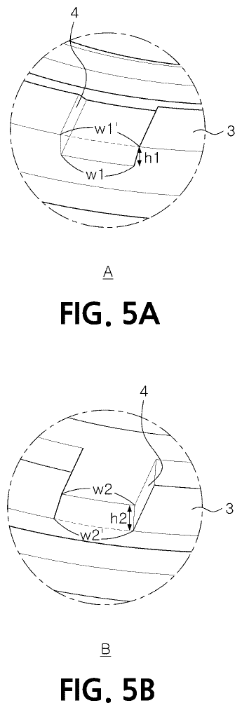

FIGS. 3A and 3B are perspective views of the first lens and the second lens of the lens module of FIG. 1, FIGS. 4A and 4B are a rear view of the first lens and a front view of the second lens of the lens module of FIG. 1, and FIGS. 5A and 5B are enlarged views of a portion of the first lens of FIG. 3A and a portion of the second lens of FIG. 3B.

Referring to FIGS. 3A and 3B, one of the first support portion RL1 and the second support portion RL2 may have a plurality of protrusions (P), and the other one thereof may have a plurality of grooves (G).

The plurality of protrusions (P) may protrude from a rib in an optical axis direction, and the plurality of grooves (G) may extend into a rib in the optical axis direction.

According to an embodiment of the present disclosure, the first support portion RL1 may have a plurality of grooves (G), and the second support portion RL2 may have a plurality of protrusions (P). The plurality of grooves (G) of the first support portion RL1 and the plurality of protrusions (P) of the second support portion RL2 may be combined with each other to align the first lens L1 and the second lens L2 in the optical axis direction.

A number of the plurality of protrusions (P) may be three or more, and a number of the plurality of grooves (G) may also be three or more.

The number of the plurality of protrusions (P) and the number of the plurality of grooves (G) may be the same. However, the present disclosure is not limited thereto.

The plurality of protrusions (P) may be spaced apart from each other in a circumferential direction of the lens. Similarly, the plurality of grooves (G) may also be spaced apart from each other in the circumferential direction of the lens.

The plurality of protrusions (P) may be disposed at equal intervals in the circumferential direction of the lens. The plurality of grooves (G) may also be disposed at equal intervals in the circumferential direction of the lens.

Hereinafter, a plurality of grooves (G) and a plurality of protrusions (P) are described in detail with reference to FIGS. 5A and 5B.

FIG. 5A is an enlarged view of a portion (A) of FIG. 3A showing one of a plurality of grooves (G) of the first lens L1, and FIG. 5B is an enlarged view of a portion (B) of FIG. 3B showing one of a plurality of protrusions (P) of the second lens L2.

In an embodiment of the present disclosure, relative to a contact surface 3 on which the first lens L1 and the second lens L2 contact each other in the optical axis direction, a length a height (h1) of the plurality of grooves (G) in the optical axis direction may be equal to a height (h2) of the plurality of protrusions (P) in the optical axis direction. That is, the plurality of grooves (G) and the plurality of protrusions (P) may contact each other in the optical axis direction when the first lens L1 and the second lens L2 are assembled.

In another embodiment of the present disclosure, the height (h1) of the plurality of grooves (G) in the optical axis direction may be greater than the height (h2) of the plurality of protrusions (P) in the optical axis direction. That is, the plurality of grooves (G) and the plurality of protrusions (P) may not contact with each other in the optical axis direction when the first lens L1 and the second lens L2 are assembled.

In an embodiment of the present disclosure, a width (w1) of a bottom of the plurality of grooves (G) in the circumferential direction as shown in FIG. 5A and a width (w2) of a top of the plurality of protrusions (P) in the circumferential direction as shown in FIG. 5B may be equal to each other.

In addition, a width (w1′) of a top of the plurality of grooves G at the contact surface 3 in the circumferential direction as shown in FIG. 5A and a width (w2′) of a bottom of the plurality of protrusions P at the contact surface 3 as shown in FIG. 5B may be equal to each other.

Accordingly, the plurality of grooves (G) and the plurality of protrusions (P) may contact each other in the circumferential direction when the first lens L1 and the second lens L2 are assembled.

In an embodiment of the present disclosure in which the height (h1) of the plurality of grooves (G) in the optical axis direction is equal to the height (h2) of the plurality of protrusions (P) in the optical axis direction, the bottom of the plurality of grooves (G) as shown in FIG. 5A and the top of the plurality of protrusions (P) as shown in FIG. 5B may contact each other in the optical axis direction when the lens L1 and the lens L2 are assembled.

In another embodiment of the present disclosure in which the height (h1) of the plurality of grooves (G) in the optical axis direction is greater than the height (h2) of the plurality of protrusions (P) in the optical axis direction, the bottom of the plurality of grooves (G) as shown in FIG. 5A and the top of the plurality of protrusions (P) as shown in FIG. 5B may not contact each other in the optical axis direction when the lens L1 and the lens L2 are assembled.

In an embodiment of the present disclosure, referring to FIG. 4A, a distance (d1) from a center of the first lens L1 to an outer edge of the plurality of grooves (G) may be smaller than an outer diameter (D1) of the first lens L1.

In addition, referring to FIG. 4B, a distance (d2) from a center of the second lens L2 to an outer edge of the plurality of protrusions (P) may be smaller than an outer diameter (D2) of the second lens L2.

Outer edges and inner edges of the plurality of grooves (G) and the plurality of protrusions (P) may have a straight shape. However, they are not limited to this shape, and may have a curved shape with a slight curvature.

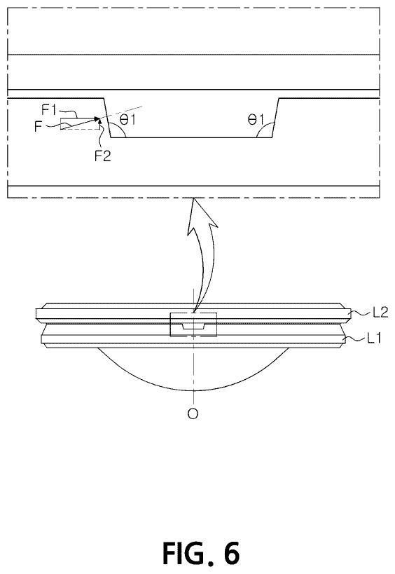

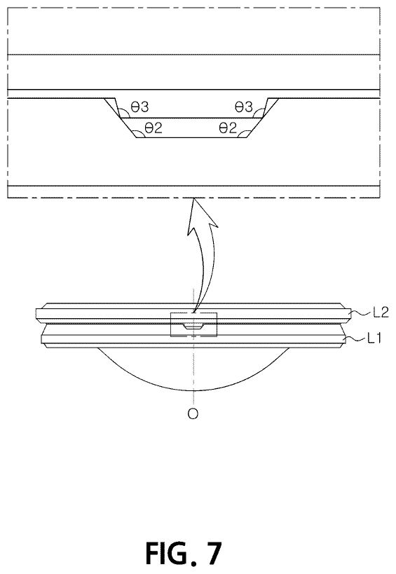

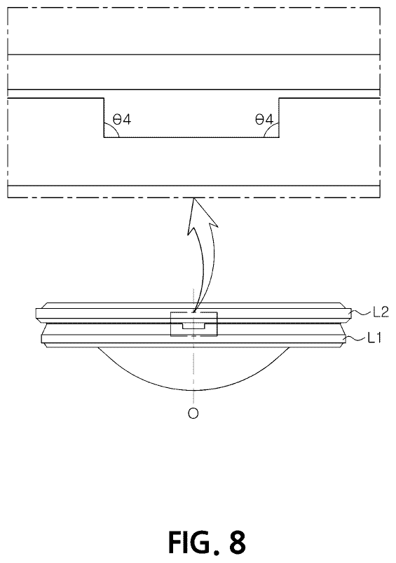

FIG. 6 is a side view of a first lens and a second lens according to an embodiment of the present disclosure, FIG. 7 is a side view of a first lens and a second lens according to another embodiment of the present disclosure, and FIG. 8 is a side view of a first lens and a second lens according to another embodiment of the present disclosure.

According to an embodiment of the present disclosure, a plurality of grooves (G) may be provided on a first support portion RL1 of a first lens L1, and a plurality of protrusions (P) may be provided on a second support portion RL2 of a second lens L2.

The plurality of grooves (G) of the first support portion RL1 and the plurality of protrusions (P) of the second support portion RL2 may be combined with each other to assemble the first lens L1 and the second lens L2.

When the first lens L1 and the second lens L2 are assembled, the plurality of grooves (G) and the plurality of protrusions (P) may contact each other in a circumferential direction.

An external assembly force (F) may be applied in the circumferential direction in which the plurality of grooves (G) and the plurality of protrusions (P) contact each other.

Since the external assembly force (F) between the lenses is applied in the circumferential direction, no moment occurs toward the center of the lens, so bending toward the center of the lens may not occur. As a result, the performance of a lens optical portion may be maintained, preventing an overall lens performance degradation.

According to an embodiment of the present disclosure, materials of the first lens L1 and the second lens L2 may be different each other. That is, the first lens L1 and the second lens L2 may be made of different materials.

When the materials of the first lens L1 and the second lens L2 are different, a thermal expansion rate, a moisture absorption rate, and other physical properties of the first lens L1 and the second lens L2 may be different, and thus the outer diameters of the first lens L1 and the second lens L2 may change by different amounts due to changes in the environment.

However, according to an embodiment of the present disclosure, the external assembly force (F) may be applied in the circumferential direction in which the plurality of grooves (G) and the plurality of protrusions (P) contact each other, so that a moment may not occur toward the center of the lens. In other words, since bending toward the center of the lens does not occur, differences in a thermal expansion rate or other physical properties between the lenses may not affect lens performance.

Preferably, the plurality of protrusions (P) may be provided on a lens having a high moisture absorption rate, and the plurality of grooves (G) may be provided on a lens having a low moisture absorption rate.

According to an embodiment of the present disclosure, an angle (θ1) formed by a surface on which the plurality of protrusions (P) and the plurality of grooves (G) contact each other in a circumferential direction and a bottom surface of the plurality of grooves (G) perpendicular to the optical axis may be an obtuse angle (θ1) as shown in FIG. 6. However, n embodiment thereof is not limited thereto, and the angle may be a right angle (θ4) as shown in FIG. 8.

According to another embodiment of the present disclosure, an angle (θ3) formed by one surface of the plurality of protrusions (P) in a circumferential direction and a bottom surface of the plurality of protrusions perpendicular to the optical axis and an angle (θ2) formed by one surface of the plurality of grooves (G) in the circumferential direction and the bottom surface of the plurality of grooves (G) perpendicular to the optical axis may be different as shown in FIG. 7.

When the angles (θ2) and (θ3) are different, the plurality of grooves (G) and the plurality of protrusions (P) may be in line contact with each other in the circumferential direction as shown in FIG. 7, rather than being in surface contact with each other in the circumferential direction as shown in FIGS. 6 and 8.

When the angles (θ2) and (θ3) are different, the plurality of grooves (G) and the plurality of protrusions (P) may be in line contact with each other in the circumferential direction as shown in FIG. 7. Accordingly, instead of a contact surface 4 extending in the outer diameter direction as shown in FIGS. 5A and 5B, 6, and 8 on which the external assembly force (F) acts, the plurality of grooves (G) and the plurality of protrusions (P) may have a contact line extending in the outer diameter direction on which the external assembly force (F) acts as shown in FIG. 7.

The contact line or contact surface on which the plurality of grooves (G) and the plurality of protrusions (P) are in contact with each other may extend in the outer diameter direction of the lens.

An angle formed by a contact surface 4 on which the plurality of protrusions (P) and the plurality of grooves (G) contact each other in the circumferential direction and a bottom surface of the plurality of grooves (G) perpendicular to an optical axis may be an obtuse angle (θ1) as shown in FIG. 6. In this case, the external assembly force (F) between the lenses may be applied in an optical axis direction (F2) in addition to the circumferential direction (F1) as shown in FIG. 6.

When the external assembly force (F) is also applied in the optical axis direction (F2), a moment may occur at the center of the lens, but the force (F2) is so small that it can be ignored.

That is, an angle formed by the contact surface 4 extending in the outer diameter direction on which the plurality of grooves (G) and the plurality of protrusions (P) are in contact with each other in the circumferential direction and the contact surface 3 perpendicular to the optical axis on which the first lens L1 and the second lens L2 are in contact with each in the optical axis direction other may be an obtuse angle.

In an embodiment, there may be a convex portion protruding in the optical axis direction from the rib of the first lens L1 and extending in the circumferential direction between the plurality of grooves (G) of the first lens L1, so that the first lens L1 and the second lens L2 may be in line contact with each other in the optical axis direction. Accordingly, when assembling the first lens L1 and the second lens L2, a contact line extending in the circumferential direction may be formed between the first lens 1 and the second lens 2 instead of the contact surface 3 extending in the circumferential direction being formed between the first lens 1 and the second lens 2.

An angle formed by the contact surface 4 extending in the outer diameter direction on which the plurality of grooves (G) and the plurality of protrusions (P) are in contact with each other in the circumferential direction and the contact line extending in the circumferential direction on which the first lens L1 and the second lens L2 are in contact with each other in the optical axis direction as discussed above may be an obtuse angle.

As a result, even if the component of the external assembly force (F) may be divided into an external force component in the optical axis direction (F2) and an external force component in the circumferential direction (F1), the external force component in the circumferential direction (F1) may be larger.

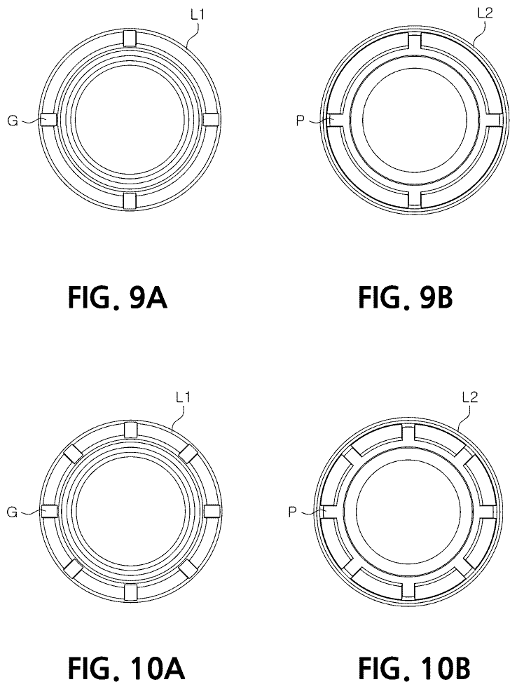

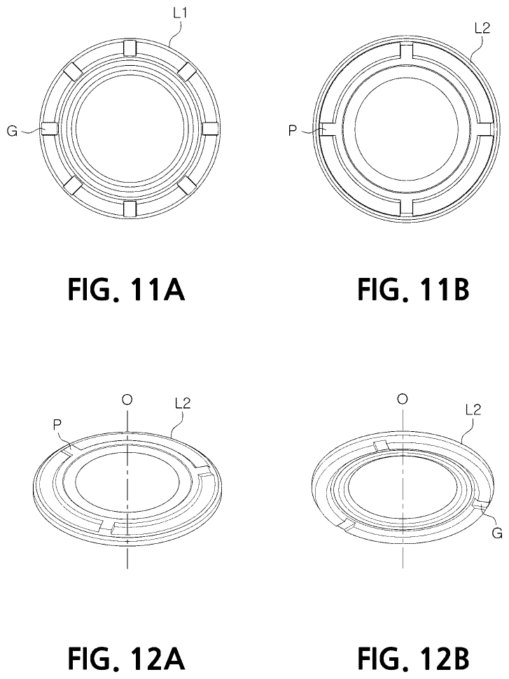

FIGS. 9A and 9B are a rear view of a first lens and a front view of a second lens according to an embodiment of the present disclosure, FIGS. 10A and 10B are a rear view of a first lens and front view of a second lens according to another embodiment of the present disclosure, and FIGS. 11A and 11B are a rear view of a first lens and a rear view of a second lens according to another embodiment of the present disclosure.

According to embodiment of the present disclosure shown in FIGS. 9A and 9B, a first lens L1 may be provided with a plurality of grooves (G), and a second lens L2 may be provided with a plurality of protrusions (P).

A number of the plurality of grooves (G) may be four, and a number of the plurality of protrusions (P) may be four.

The plurality of grooves (G) and the plurality of protrusions (P) may be spaced apart from each other in a circumferential direction of a lens.

The plurality of grooves (G) may be disposed at equal intervals in the circumferential direction, and the plurality of protrusions (P) may also be disposed at equal intervals in the circumferential direction.

According to the embodiment of the present disclosure shown in FIGS. 10A and 10B, the first lens L1 may be provided with a plurality of grooves (G), and the second lens L2 may be provided with a plurality of protrusions (P).

A number of the plurality of grooves (G) may be eight, and a number of the plurality of protrusions (P) may be eight.

The plurality of grooves (G) and the plurality of protrusions (P) may be spaced apart from each other in a circumferential direction of a lens, respectively.

The plurality of grooves (G) may be disposed at equal intervals in the circumferential direction, and the plurality of protrusions (P) may also be disposed at equal intervals in the circumferential direction.

However, the number of the plurality of grooves (G) and the number of the plurality of protrusions (P) are not limited to the numbers in the embodiments described above, and different numbers of grooves (G) and protrusions (P) may be provided in other embodiments.

According to the embodiment of the present disclosure and the first embodiment and the second embodiment, a plurality of grooves (G) provided in the first lens L1 and a plurality of protrusions (P) provided on the second lens L2 may be combined to form an assembly between the lenses.

When the lenses are assembled as above, the lens may be assembled in a certain direction without rotating, which may improve assembly reproducibility and, as a result, improve a lens yield.

According to the embodiment of the present disclosure shown in FIGS. 11A and 11B, the first lens L1 may be provided with a plurality of grooves (G), and the second lens L2 may be provided with a plurality of protrusions (P). The first lens L1 may be provided with eight grooves (G), and the second lens L2 may be provided with four protrusions (P).

That is, a number of grooves (G) provided in the first lens L1 may be greater than a number of protrusions (P) provided on the second lens L2.

The plurality of grooves (G) may be disposed at equal intervals in a circumferential direction, and the plurality of protrusions (P) may also be disposed at equal intervals in the circumferential direction.

When the number of the plurality of grooves (G) is greater than the number of the plurality of protrusions (P), a degree of freedom in an assembly direction may increase.

As a result, the number of the plurality of grooves (G) provided in the first lens L1 may be equal to or greater than the number of the number of the plurality of protrusions (P) provided on the second lens L2.

FIGS. 12A and 12B are perspective views of an object-side surface and an image-side surface of a first lens according to another embodiment of the present disclosure.

FIG. 12A is a perspective view of an object-side surface of a second lens L2 relative to an optical axis O, and FIG. 12B is a perspective view of an image-side surface of the second lens L2 relative to the optical axis O.

The second lens L2 may have both a plurality of protrusions (P) on the object-side surface as shown in FIG. 12A, and a plurality of grooves (G) on the image-side surface as shown in FIG. 12B. Alternatively, although not shown, the second lens L2 may have both a plurality of grooves (G) on the object-side surface, and a plurality of protrusions (P) on the image-side surface.

Alternatively, although not shown, the second lens L2 may have both a plurality of protrusions (P) on the object-side surface, and a plurality of protrusions (P) on the image-side surface. Alternatively, although not shown, the second lens L2 may have both a plurality of grooves (G) on the object-side surface, and a plurality of grooves (G) on the image-side surface.

However, as shown in FIGS. 12A and 12B, it may be preferable from the perspective of mechanism formability to have a plurality of protrusions (P) on one surface of the second lens L2, and a plurality of grooves (G) on the other surface of the second lens L2.

However, the embodiment of FIGS. 12A and 12B and the variations discussed above are not limited to the second lens L2, but may also be applied to other lenses.

As set forth above, according to the present disclosure, a lens module in which bending of a lens even when subjected to impacts or environmental changes is prevented, thereby preventing degradation of lens optical performance, may be provided.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module comprising:
a lens barrel having an internal space; and
a first lens and a second lens disposed in the lens barrel along an optical axis direction,
wherein each of the first lens and the second lens comprises an optical portion exhibiting an optical characteristic, and a support portion extending from the optical portion in an outer diameter direction perpendicular to the optical axis direction,
the support portion of the first lens comprises one of a plurality of grooves and a plurality of protrusions spaced apart from each other in a circumferential direction perpendicular to the optical axis on a surface of the support portion of the first lens facing the second lens, and the support portion of the second lens comprises another one of the plurality of grooves and the plurality of protrusions spaced apart from each other in the circumferential direction on a surface of the support portion of the second lens facing the first lens, and
the plurality of grooves and the plurality of protrusions contact each other in the circumferential direction.

2. The lens module of claim 1, wherein the support portion of the first lens and the support portion of the second lens are spaced apart from each other in the outer diameter direction.

3. The lens module of claim 1, wherein the first lens and the second lens are made of different materials having different moisture absorption rates, and
the plurality of protrusions are disposed on one of the first lens and the second lens having a higher moisture absorption rate among the first lens and the second lens.

4. The lens module of claim 1, wherein a number of the plurality of grooves is at least three, and a number of the plurality of protrusions is at least three.

5. The lens module of claim 4, wherein the number of the plurality of grooves is greater than the number of the plurality of protrusions.

6. The lens module of claim 1, wherein the plurality of grooves are disposed at equal intervals in the circumferential direction, and
the plurality of protrusions are disposed at equal intervals in the circumferential direction.

7. The lens module of claim 1, wherein a height of the plurality of grooves in the optical axis direction is greater than a height of the plurality of protrusions in the optical axis direction.

8. The lens module of claim 1, wherein a distance from a center of the first lens to outer ends of the plurality of grooves or the plurality of protrusions in the outer diameter direction is smaller than an outer diameter of the first lens, and
a distance from a center of the second lens to outer ends of the plurality of grooves or the plurality of protrusions in the outer diameter direction is smaller than an outer diameter of the second lens.

9. The lens module of claim 1, wherein an angle formed by each surface of each groove of the plurality of grooves contacting a respective protrusion of the plurality of protrusions in the circumferential direction and a bottom surface of the groove perpendicular to the optical axis direction is an obtuse angle.

10. The lens module of claim 9, wherein the plurality of protrusions and the plurality of grooves are in line contact or surface contact with each other in the circumferential direction.

11. The lens module of claim 10, wherein a line or a surface on which the plurality of protrusions and the plurality of grooves contact each other in the circumferential direction extends in the outer diameter direction.

12. A lens module comprising:
a lens barrel having an internal space; and
a first lens and a second lens disposed in the lens barrel along an optical axis direction,
wherein the first lens and the second lens contact each other in a circumferential direction perpendicular to the optical axis direction,
the first lens comprises one of a plurality of grooves and a plurality of protrusions spaced apart from each other in the circumferential direction on a surface of the first lens facing the second lens, and the second lens comprises another one of the plurality of grooves and the plurality of protrusions spaced apart from each other in the circumferential direction on a surface of the second lens facing the first lens, and
the plurality of grooves and the plurality of protrusions contact each other on contact surfaces or contact lines extending in an outer diameter direction perpendicular to the optical axis direction and the circumferential direction, and are pressed together in the circumferential direction by a force acting in the circumferential direction.

13. The lens module of claim 12, wherein a number of the plurality of grooves is at least three, and a number of the plurality of protrusions is at least three.

14. The lens module of claim 13, wherein the number of the plurality of grooves is equal to or greater than the number of the plurality of protrusions.

15. The lens module of claim 12, wherein a distance from a center of the first lens to outer ends of the plurality of grooves or the plurality of protrusions in the outer diameter direction is smaller than an outer diameter of the first lens, and
a distance from a center of the second lens to outer ends of the plurality of grooves or the plurality of protrusions in the outer diameter direction is smaller than an outer diameter of the second lens.

16. The lens module of claim 12, wherein an angle formed by each surface of each groove of the plurality of grooves contacted by a respective protrusion of the plurality of protrusions on a respective contact surface or a respective contact line of the contact surfaces or the contact lines and a bottom surface of the groove perpendicular to the optical axis direction is an obtuse angle.

17. The lens module of claim 12, wherein the plurality of grooves are disposed at equal intervals in the circumferential direction, and the plurality of protrusions are disposed at equal intervals in the circumferential direction.

18. The lens module of claim 12, wherein the first lens and the second lens are spaced apart from each other in the outer diameter direction.

19. The lens module of claim 12, wherein the first lens and the second lens are made of different materials having different moisture absorption rates, and
the plurality of protrusions are disposed on one of the first lens and the second lens having a higher moisture absorption rate among the first lens and the second lens.

20. The lens module of claim 12, wherein a height of the plurality of grooves in the optical axis direction is greater than a height of the plurality of protrusions in the optical axis direction.
